(19) United States
(12) Patent Application Publication
(10) Pub. No.: US 2022/0237849 A1
(43) Pub. Date: Jul. 28, 2022

(54) Method and system for reducing processor load in a computer

(71) Applicant: Tobii AB, Danderys (SE)

(72) Inventor: Fredrik Lindh, Danderyd (SE)

(73) Assignee: Tobii AB, Danderyd (SE)

(21) Appl. No.: 16/915,438

(22) Filed: Jun. 29, 2020

(30) Foreign Application Priority Data
Jun. 28, 2019 (SE) 1950812-6

(51) Int. Cl. G06T 15/00; G06F 9/50; G06T 13/00; G06T 15/20

(52) U.S. Cl. CPC G06T 15/005; G06T 15/20; G06T 13/00; G06F 9/505

(57) ABSTRACT

Method for reducing processor load in a system rendering a virtual scene to produce a rendered presentation of said virtual scene, which scene comprises at least one animated object, wherein the system performs said rendering based on said virtual scene which in turn is animated by the system based on a set of predefined animation rules, wherein the method comprises the steps:

determining, based on information from a gaze direction detection means , a first zone or point of the virtual scene as a zone to which a gaze of the user is currently directed;

determining a relative location or distance of a first object as a location in relation to said first zone or point; and

modifying the value of an animation updating frequency of said first object per-formed by the system as a function of said determined relative location or distance.

The invention also relates to a system and to a computer software function.

### CROSS REFERENCE TO RELATED APPLICATIONS

This application claims priority to Swedish Application No. 1950812-6 filed Jun. 28, 2019; the content of which are hereby incorporated by reference.

### TECHNICAL FIELD

The present invention relates to a method for reducing processor load in a computer, in particular in a computer rendering a virtual, simulated scene such as a two-dimensional (“2D”) or three-dimensional (“3D”) virtual scene. The processor load reducing is achieved using a detected current gaze direction of a user in relation to said scene. The invention also relates to a system and to a computer software function for performing such a method.

Embodiments of the present invention relate to tracking a user's gaze when the user is observing such a scene, and to selectively change a level of simulation complexity in areas of the scene distanced from a current user gaze point.

### BACKGROUND OF INVENTION

It is known to detect an eye and its gaze direction. This can be done, for example, by illuminating a region in which the eye is sought with infrared radiation; capturing an image of the region; and detecting bright spots in the image that derive from the pupil and cornea of the eye. This approach exploits the bright-eye or “red-eye” effect known to photographers, whereby light enters the eye and is reflected or absorbed and re-emitted through the pupil, making the pupil appear brighter than the rest of the eye and the face.

A separate, smaller bright spot (also referred to as a glint) is created by the cornea. The relative positions of the pupil and the corneal glint can be used to determine the direction of the gaze of the eye. More details are given in U.S. Pat. No. 6,152,563.

Alternatively, or in addition thereto, a similar technique may be used whereby infrared illuminators are spaced from an image sensor, thus an image captured by the image sensor has a non-bright pupil, otherwise known as a “dark pupil” effect.

This gaze tracking technology may be implemented in a remote gaze tracker located adjacent a display for example, or in a wearable device such as a pair of glasses, a virtual reality headset, an augmented reality headset, a helmet or the like.

Such gaze tracking technology can be used to determine if a user is looking at a particular object or an area on a screen (these objects or areas are generically referred to as ‘zones’ in the present application). This could be as part of a game, for example, allowing users to interact with images on a screen by looking at them (the act of looking at the image having a predetermined result) or by a combination of looking at an image and another control (e.g., a user pressing a key on a keyboard or mouse whilst their gaze is directed at the image).

When determining where in relation to a scene the gaze of a user is currently directed, consideration must be taken to the physical gaze direction of the user, in relation to a physical viewing region such as a screen. However, consideration must also be taken to the current state of the scene itself, and to the virtual camera's current virtual space position and direction. This is true both for 2D and 3D scenes.

Herein, a “simulated” scene means a scene the final presentation or appearance of which results from some type of computer simulation of a defined virtual model. The final presentation in question is in the form of a 2D image (such as a bitmap on a screen display) or a 3D image (such as a hologram). The “simulation” in question happens before the rendering of the final presentation, and comprises taking into consideration dynamic properties of the scene, such as mutable objects present in the scene and/or geometric transformations of the defined virtual model itself (in virtual space) in relation to a defined viewpoint of a user. Typically, such “simulation” takes into consideration certain prede-fined rules, that may form part of the definition of said virtual model, regarding how such mutations will progress over time in an at least partly, or at least statistically, deterministic manner based on such rules.

Hence, virtual models relevant to the present application are virtual models that can change dynamically, resulting in a correspondingly modified final rendered presentation for a user.

For instance, a 2D model can comprise animated characters that interact with the virtual environment, with each other and/or with a character controlled by the user, resulting in w such dynamical changes of the simulated model.

In a 3D model, the simulated model is normally defined in the form of a virtual 3D structure, the objects contained in which follow certain well-defined rules for interaction. For instance, a physics engine can be used by a simulating computer to calculate object trajectories and so forth that would apply in a corresponding physical world, in order to give a realistic finally rendered presentation to the user. As another example, 3D objects may themselves be mutable, for instance by a surface texture or a geometric shape of the object in question changing over time.

Dynamic changes of the above exemplified types may lead to complex interactions between objects, where one event triggers or affects one or several downstream events and so forth. For instance, if a virtual rocket is launched onto a virtual house, this may lead to the house partly or completely being destroyed, such as by the walls and the ceiling falling down. This may, in turn, affect the position and orientation of objects on the ground near the falling walls, and so forth.

As mentioned, a simulating computer may also employ animation techniques using which certain objects move or otherwise transform according to a defined set of rules. For instance, animated grass may move with a virtual wind and a character may be able to move across a set number of degrees of freedoms defined by a skeletal mesh model of the character. Such animation may be the result of a predetermined process; a computer-internal artificial intelligence (“AI”) process and/or user control.

Once the current state of such a scene at a particular point in time has been defined, the computer translates the scene into a presentation to be displayed to the user. In the common case of a 3D scene to be presented to the user as a 2D image, this process is called “rendering”. Herein, the term “rendering” is used for both 2D and 3D scenes, and for both 2D and 3D presentations, and is intended to have the corresponding meaning for other combinations between scene/presentation dimensionality than 3D/2D.

To this end, it is noted that the action of “simulating” and “rendering”, as these terms are used herein, denote two different steps performed by the simulating computer. “Simulating” may include an animation step, and aims at providing a well-defined scene state to be used in the rendering state. Then, “rendering” means the process of transforming that well-defined scene state onto the physical presentation medium. Both in the case of a 2D and a 3D scene, this rendering may include such things as calculating a respective colour of each pixel or voxel of the presentation, based on the scene state in question.

Depending on scene complexity and presentation quality, the load on a CPU (Central Processing Unit) and/or a GPU (Graphics Processing Unit) of a simulating computer may vary. Often, such as in a computer game, there is a trade-off between scene complexity and presentation quality. It is known, for instance from U.S. Pat. No. 9,665,171, to use gaze information to affect this trade-off, such as by reducing presentation pixel resolution in areas of a computer screen to which areas the user is not presently directing her gaze.

However, the available CPU/GPU budget is still often a limiting factor for providing a better user experience of such simulations.

WO 2018/227100 A discloses a system in which different shadow maps, of different graphical detail, are used for different parts of a screen as a function of where on the screen the attention of the user is directed. In this document, a bone structure of a character may also be simplified if a character is outside of such an attention area.

### SUMMARY OF INVENTION

Hence, the invention relates to a method for reducing processor load in a system rendering a virtual scene to produce a rendered presentation of said virtual scene, which scene comprises at least one animated object, wherein the system performs said rendering based on said virtual scene which in turn is animated by the system based on a set of w predefined animation rules, wherein the method comprises the steps: determining, based on information from a gaze direction detection means, a first zone or point of the virtual scene as a zone to which a gaze of the user is currently directed; determining a relative location or distance of a first object as a location in relation to said first zone or point; and modifying the value of an animation updating frequency of said first object per-formed by is the system as a function of said determined relative location or distance.

Furthermore, the invention relates to a system arranged to render a virtual scene to produce a rendered presentation of said virtual scene, which scene comprises at least one animated object, which system is arranged to perform said rendering based on said virtual scene and to animate said virtual scene based on a set of predefined animation rules, which system is arranged to: determine, based on information from a gaze direction detection means, a first zone or point of the virtual scene as a zone to which a gaze of the user is currently directed; determine a relative location or distance of a first object as a location in relation to said first zone or point; and modify the value of an animation updating frequency of said first object as a function of said determined relative location or distance.

Moreover, the invention relates to a computer software function arranged to, when executing, render a virtual scene to produce a rendered presentation of said virtual scene, which scene comprises at least one animated object, which software function is further arranged to, when executing, perform said rendering based on said virtual scene and to animate said virtual scene based on a set of predefined animation rules, which software function is further arranged to, when executing: determine, based on information from a gaze direction detection means, a first zone or point of the virtual scene as a zone to which a gaze of the user is currently directed; determine a relative location or distance of a first object as a location in relation to said first zone or point; and modify the value of an animation updating frequency of said first object as a function of said determined relative location or distance.

In the following, the invention will be described in detail, with reference to exemplifying w embodiments of the invention and to the enclosed drawings, wherein:

### BRIEF DESCRIPTION OF DRAWINGS

FIG. 1 is a diagram for explaining how a 3D scene is rendered as a 2D image;

FIG. 2 is a diagram of a system for implementing gaze detection;

FIG. 3 is a flow chart illustrating a method according to the present invention;

FIG. 4 illustrates a rendered version of a first scene; and

FIG. 5 illustrates a rendered version of a second scene.

In all Figures, same reference numerals refer to same or similar parts.

### DETAILED DESCRIPTION

The present invention relates to gaze tracking, such as with respect to a 3D scene. The term gaze tracking is used herein to refer to any method or system that detects and/or monitors the location of an eye and/or the direction of the gaze of an eye. The skilled reader will be aware of and understand such systems.

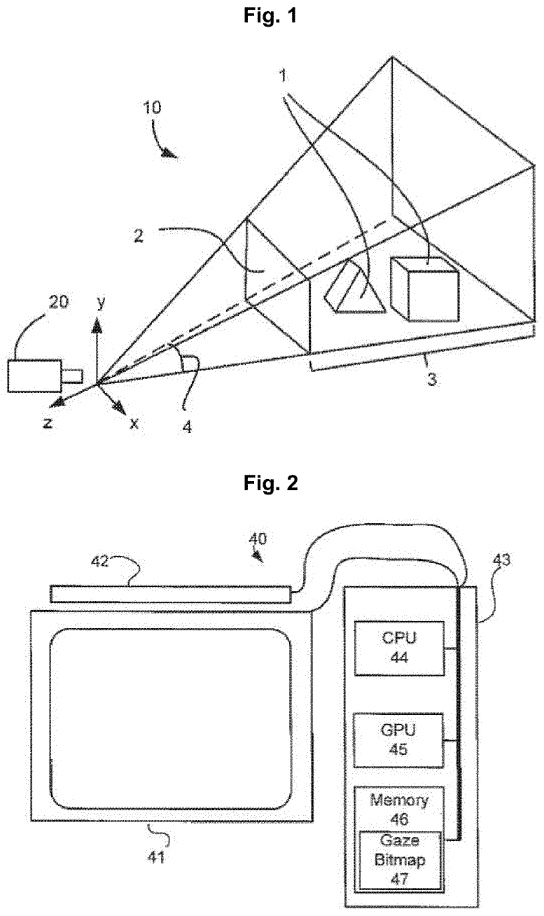

FIG. 1 provides an example of a scene 10. The example presented in FIG. 1 relates to a simulated 3D scene being rendered on a physical 2D surface, but it is realized that what is said herein is correspondingly applicable to a simulated 2D scene, as well as to a rendering into a 3D presentation, as mentioned above. Hence, the scene 10 can be a virtual 3D scene, such as in a computer game or created for a virtual reality headset. The scene 10 contains 3D objects 1. Such objects 1 may move within the scene 10 over time. Indeed, the objects 1 may also move out of the scene 10 and other objects may move into the scene. When such 3D scenes are viewed on a monitor or computer screen, the monitor or screen presents a 2D image representing a view on the 3D scene from a particular location in space, through a viewport 2. The viewport 2 delimits the image that would be seen by a virtual camera 20 or eye located at a notional position with respect to the 3D scene 10. The combination of the position of the virtual camera 20 and the viewport 2 sets the field of view 4. FIG. 1 also shows the view frustum 3, which is the region of the 3D scene 10 (i.e., extending to the rearmost part of the 3D scene 10) that is shown in the viewport 2.

The FIG. 1 diagram also applies to stereoscopic images, such as used in virtual reality headsets for example. In that case, each eye of a user is presented with a slightly different viewport 2 onto a scene 10, from which the user's brain then perceives a single 3D image.

In this case each image is usually deformed in a non-linear fashion to compensate for lens characteristics. However, the underlying concepts are the same as discussed with reference to FIG. 1 for each image presented to each of the user's eyes.

The 3D objects 1 may be notionally infinitely complex 3D shapes, constructed from polygons. The image viewed via the viewport 2 is a 2D projection of the 3D objects 1 onto the plane of the viewport 2 as seen from the position of the virtual camera 20, as discussed above. However, the screens on which the 2D viewport 2 images are displayed are composed of arrays of discrete elements or pixels. As such, the projections of the 3D objects 1 must be rasterized onto a display grid, by sampling the projected image at each of the screen pixel locations, to produce the image that will be presented as the visual scene (i.e., the scene observed through the viewport 2). The pixel values are stored in a memory area or buffer, as a 2D “bitmap” corresponding to the same dimensions as the screen or viewport 2.

Herein, such rasterization is herein generally denoted a “sampling” of the 3D scene, and form part of the rendering process. The sampling is hence performed by a rendering function, so as to produce said rendered 2D projection image of the 3D scene 10, and is performed by the rendering function based on, inter alia, properties of the virtual camera 20. Such properties of the virtual camera 20, in turn, may comprise a position of the virtual camera 20 and a direction of the virtual camera 20 in relation to the virtual 3D scene 10 in question. In other words, the virtual camera 20 is located at a particular point in virtual 3D space, and is directed in a particular virtual 3D space direction. The rasterized 2D image will depend on both the contents of the virtual 3D scene, as well as on the said camera 20 position and direction.

It is noted that the “virtual camera direction”, as used herein, being a direction vector from the virtual camera position to the centre of the viewport 2, can be thought of as analogous to a relative position in virtual 3D space between the virtual camera 20 and the viewport 2, and in particular of an angular position in virtual 3D space of the viewport 2 in relation to the virtual camera 20.

The virtual camera 20 may also have additional static or variable properties, such as an angle of view (corresponding to fisheye/tele), a lens correction transform, and similar, also affecting the final rasterized 2D image. Furthermore, the result of the sampling is also dependent on a current state of the animated 3D scene, in turn being dependent on a sampling time point.

It is noted that the term “bitmap” has a number of possible meanings. In the context of the present invention, and as is common in the field of computer graphics, it is used to refer to the concept of a spatially mapped array of pixels, which can also be known as a “pixmap”. The term bitmap is not intended to convey any limitation in terms of the bit depth of the stored information. In the present invention, the bit depth of the stored information can be variable.

FIG. 2 shows a schematic view of a system 40 according to the present invention, in which the said gaze-detection may be implemented. The system 40 includes a screen 41 or a monitor 41 and gaze-detector (a gaze direction detection means) 42. The screen 41 may take a conventional or non-conventional form, including a virtual screen such as a retinal projector or a heads-up display in a vehicle. Both the gaze direction detection means 42 and the screen 41 are connected to a computer 43. In modern computers 43, the graphical processing unit (GPU) 45 is often 10-100 times faster than the central processing unit (CPU) 44 for parallelizable computations. As will be clear from the following, the present invention may be implemented using a GPU 45 and/or a CPU 44 of said ypes.

The computer 43 further comprises a memory 46 into which the said 2D image can be stored as a bitmap 47.

On the hardware of the computer 43, a piece of software according to the present invention is arranged to be executed, performing the method steps of a method according to the present invention. A system 40 according to the present invention comprises the computer 43 on which said software is arranged to execute so as to perform a method according to the present invention. The system 40 may also comprise the software as such.

The system 40 may also comprise the gaze direction detecting means 42. However, in some embodiments the gaze direction detection means 42 is provided as a peripheral device to a system 40 according to the present invention.

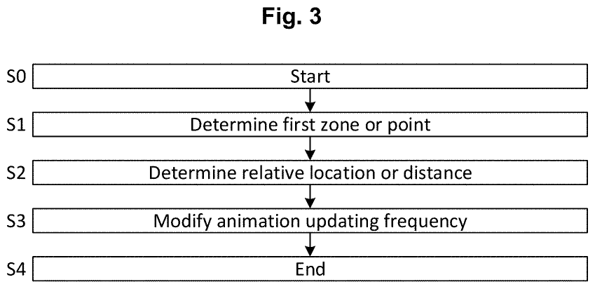

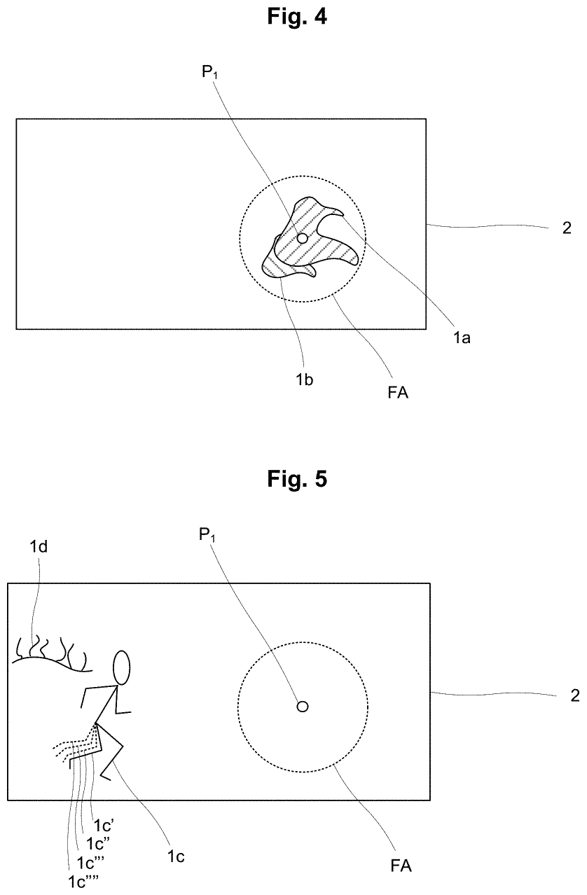

FIG. 3 illustrates a method according to the present invention, for reducing processor load in a system 40 rendering a virtual scene 10 of the above described type, to produce a rendered presentation of said virtual scene 10. FIG. 4 illustrates a scene 10 exemplifying said method illustrated in FIG. 3. The scene 10 in FIG. 4 is shown in a rendered state, in other words as viewed by a user on for instance a display screen.

As described above, the scene 10 comprises at least one animated object 1. The system 40 performs said rendering based on said virtual scene 10, which in turn is animated by the system 40 based on a set of predefined animation rules.

In other words, the system 40 has knowledge of the characteristics of the virtual scene 10 at each moment in time, such as of the location, orientation, geometric shape and surface patterns of the objects 1 contained in the scene. The system 40 furthermore has knowledge about a predefined set of rules affecting the temporal development of the scene 10, for instance using a physics engine determining the development over time of said characteristics of the scene 10, including said objects 1. Such animation leads to the state of the scene 10 developing over time. The system 40 is then arranged to repeatedly, at different consecutive time points, render a user presentation of the then current state of the scene 10.

Typical rendering time intervals may vary between 20 and 200 frames per second (“rendering frequency”). The animation may be updated each time the rendering is updated, or at other intervals (“updating frequency”).

In a first step S0, the method starts.

In a subsequent step S1, it is determined, such as by the system 40, using the gaze direction detection means 42, a first zone or point of the virtual scene 10 as a zone to which a gaze of the user is currently directed.

In FIG. 4, the rendered scene 10 comprises two objects 1a and 1b. Object la is in the foreground, while object 1b is in the background. A gaze point P₁ on the viewport 2 onto which the user currently directs her gaze is determined by the gaze direction detection means 42, and this information is provided to said software function executing on the system 40 hardware.

In different embodiments of the present invention, the “zone or point” may mean different things. FIG. 4 illustrates a number of examples of this.

In one embodiment, the current gaze point P₁ may constitute the “zone or point” (in this particular case indeed being a “point”). It is realized that, in the present 2D rendering example, the gaze point P₁ is equivalent to a gaze direction detected by the gaze direction detection means 42 in relation to the scene, the gaze point P₁ being located at the intersection between a three-dimensional gaze direction ray and a calibration plane, such as the two-dimensional viewport 2, present in three-dimensional space.

In a different embodiment, the “zone or point” may be an area FA surrounding the gaze point P₁, which area FA may be a conventional “foveal area”, in other words an area which is sufficiently close to the gaze point P₁, in angular terms, so that the observing user has a clear view of graphical details within the area FA. Such an area FA may be defined in terms of the gaze point P₁ together with a maximum (two-dimensional) distance in the viewport to the gaze point P₁, or a maximum viewing angle in three-dimensional space in relation to the said gaze ray, forming an elliptical, such as circular, (in the two-dimensional viewport 2) or cone-shaped (in three-dimensional space) foveal area surrounding the gaze point P₁. Hence, this corresponds to a simple “cone test” or “frustum test” to tell if an object 1 is within a foveal area of the user or not. Such cone or frustum tests are conventional as such, and will not be detailed herein.

In a different embodiment, the “zone or point” may be defined in terms of one or a set of objects 1 being present within, or sufficiently close to (according to a predetermined closeness criterion), such a foveal area. For instance, such an object, or such a set of objects, may form a graphical entity which it is assumed, according to such closeness criterion, that the user views as one single viewing context. For instance, the whole geometric extension of a game character (or other object 1) on which the gaze point P₁ is currently present may form the said “zone or point”. The corresponding may be the case for an object (such as a table) or a set of objects (such as a set of a table and chairs) on which the gaze point P₁ is currently present. In this alternative, it is hence question of a “currently observed” object or set of objects that define(s) the said “zone or point”. The determination of such currently observed objects based on the gaze point P₁ may vary, and is typically performed by said software function based on a set of predetermined object selection rules, that may be comprised in said closeness criterion, that in turn may be context and situation dependent.

Thus, such a “zone” may be a two-dimensional zone in the plane of the viewport 2. Alternatively, such a “zone” may be a three-dimensional zone in virtual 3D space.

It is realized that these different ways of determining the “zone or point” may be combined to form more complex zones. For instance, an elliptical or non-elliptical foveal area may be combined with a set of currently observed objects together forming an irregular “zone” covering said currently observed objects and also an additional field of the viewport 2.

It is preferred that the “zone or point” is determined based on the currently detected gaze point P₁ or gaze ray/direction, as determined using the gaze direction detection means 42.

In the particular case where the user's gaze travels across the viewport 2, the “zone or point” may be dynamically adapted to such movement. In particular, the “zone or point” may have a longer viewport 2 coordinate system extension, along the viewport 2 surface, in a direction in which the user's gaze is currently travelling (across the viewport 2) as compared to along an extension being perpendicular thereto.

In case a user saccade or other sudden gaze point P₁ jump is detected, the “zone or point” may be expanded so as to cover a bigger part of the plane of the viewport 2. Alternatively, when a saccade or other ambiguous or uncertain user gaze direction situation is detected, the present method may be temporarily discontinued or disabled, in the sense that a default animation updating frequency may be used for all animated objects 1 in the scene 10 until an unambiguous gaze direction can again be determined.

In a subsequent step S2, the system 40 determines a relative location of a first object 1 as a location in relation to said determined zone or point, or a distance of the first object 1 to the determined zone or point.

This relative location or distance may be binary, such as if the first object 1 is within a determined zone or not within the zone. Alternatively, the relative location may be a stepwise or continuous function of a distance between a determined zone or point and the first object 1. This will be exemplified below.

In a subsequent step S3, the value of an animation updating frequency of the first object 1 is modified as a function of said determined relative location or distance.

It is realized that the “distance” can be viewed as a special case of a “relative location”. Herein, these two expressions are interchangeable. In particular, the distance in question is may be a distance in the plane of the viewport 2, or a distance in three-dimensional space. In some embodiments, the distance is a distance onto the projected viewport 2 plane.

Hence, the “relative location” may be the same thing as a “distance”. However, a “relative location” may also take into consideration context-specific geometric information, such as if the object 1 in question is located in foreground or in a background; if it is partly hidden behind another object or fully visible; and if it is in a current direction of gaze point P₁ movement.

By modifying the animation updating frequency based on the said distance, the corresponding processor load, associated with performing the animation updates, can be reduced, in particular so that the animation of parts of the scene 10 directly observed by the viewing user can be more frequent than the animation of parts of the scene 10 not directly observed by the viewing user. By focussing the available processor time on objects 1 that are actively viewed an optimized user experience can be achieved.

Hence, using the present invention the CPU usage may be optimized and used where it makes the most difference to the actual user experience. In practise, CPU savings are achieved as a combination of updating the animation system (determining what objects 1 should be animated and how) and actually performing the update of the animation.

It is important to realize that using a decreased animation updating frequency in parts not currently viewed is quite different to using decreased graphical rendering resolution in non-viewed parts. Firstly, in very complex animation situations, such as when there are many animated foreground game characters, reducing resolution outside of a foveal area of the viewport 2 may only have a marginal effect on the total CPU 44 load of the system 40. Secondly, the resolution only affects the rendering function of the system 40, not its animation function. The rendering function will typically primarily use a GPU 45 of the system 40, while the animation will typically have a relatively heavier reliance on a CPU 44 of the system 40. Hence, for CPU 44 constrained animation/rendition situations, decreasing the rendering resolution will not in itself achieve any major results in terms of user experience.

It is further noted that said “modification” of the animation updating frequency may be an increased and/or decreased animation updating frequency, depending on how the user's gaze sweeps across the viewport 2 and/or depending on the geometric changes of the objects 1 in the scene 10 over time.

Different objects 1 in the scene 10 may hence have different animation updating frequencies at the same time, depending on their geometric relationship to said zone or point, and ultimately in relation to the user's gaze. In fact, one important insight lying behind the present invention is to distribute the computational resources across various parts of the scene 10 on object level rather than based on the rendered view (where a certain pixel is on the viewing display).

It is preferred that, for an object 1 the animation updating frequency of which is modified, the animation updating frequency in question is decreased as a function of increasing relative location or distance of the object 1 in question to said zone or point. Hence, the further away from the zone or point (and typically, from the gaze point P₁), the lower the animation updating frequency applied to the object 1.

In a subsequent step S4, the method ends.

FIG. 5 illustrates, like FIG. 4, a detected current gaze point P₁, as well as a foveal area FA which could be said zone. Furthermore, FIG. 5 illustrates two different types of objects: a running character 1c and grass 1d moving with a virtual wind.

The character 1c is an example of an object defined at least partly in terms of a movable skeletal mesh. For such skeletal mesh-defined objects, the animation of which has an animation updating frequency which is varied according to the present invention, the said animation comprises determining a movement of the skeletal mesh of the object 1c in question. Hence, the arms and legs of the skeletal mesh will move as the character runs across the scene 10, as a result of an animation performed by the system 40 in a step upstream of a rendering step as described above. It is then the updating frequency of this movement which is varied as a function of the relative position or distance to the zone or point in question. In some embodiments, a translational movement of such an object is not affected by the reduction of the animation frequency of the present type. Instead, in this case it is only an updating frequency of the animation of a movement of the character itself that is reduced, while the translation of the object in 3D space in question is updated at a default or otherwise prevailing animation frequency.

For such objects 1c being at least partly defined by a skeletal mesh, the animation (the determination by the system 40 of the movement of the skeletal mesh) is often CPU 44 constrained. Hence, by reducing the updating frequency of such animation, of objects lc being far from the point of zone to which the user directs her attention, will lead to the CPU 44 being burdened with fewer skeletal mesh animation updates per time unit, whereby the CPU 44 can be put to use doing other tasks.

The present application is particularly useful when it comes to objects 1 defined at least partly by a skeletal mesh, and in particular where skeletal mesh movements may result in an interaction between the object 1 in question and a second object in the scene 10, in turn affecting the animation of the virtual scene 10. In such circumstances, the animation is particularly prone to being CPU 44 constrained, why lowering the animation updating frequency for objects outside of a part of the scene 10, which part is currently not being actively viewed, will typically lead to large gains in terms of released CPU time.

The grass 1d is an example of an object of a different type, the animation of which comprises a shader animation. A “shader animation” is an animation using a shader program or algorithm, such as a vertex, geometry or tessellation shader. Normally, shaders perform many similar operations in parallel, such as operations on individual pixels or vertices. Such shaders are conventional as such, and will not be discussed in detail herein. However, one common trait for all such shader animations is that the shader animation does not is result in a geometric interaction between the object 1 in question on which the shader animation operates and any other object in the scene 10.

Due to the nature of the shader animation, it may be GPU 45 constrained. In many situations, it makes sense to decrease the animation update frequency for such shader animated objects 1 in parts of the scene that are currently not actively viewed by the user. For instance in the case of the grass 1d, the grass 1d may wave in the virtual wind. In case the user looks directly at the grass 1d, a normal animation updating frequency, say one animation update for each rendered frame, will make the grass 1d wave smoothly. However, in case the user instead directs her gaze elsewhere, such as to the point P₁, it may suffice to update the grass 1d waving animation less frequently, such as once every second rendered frames, without the user necessarily noticing a difference.

In some embodiments, the system 40 may measure a viewing distance of the animated object 1 in the virtual scene 10, and reduce the animation updating frequency as a function of increasing viewing distance of the object 1 in question. It is realized that “viewing distance” in this case may be or correspond to the distance in virtual space between the virtual camera 20 and the object 1 in question.

Another factor that may be used to affect the animation updating frequency is a level of detail (“LOD”) of the animated object 1. Hence, the animation updating frequency may be reduced as a function of decreasing level of detail of the animated object 1, so that the animation of more complex objects is updated more frequently than less complex objects for identical relative positions or distances of the object in question from the above described point or zone.

Correspondingly, the velocity of the animated object 1 may be used to modify the animation updating frequency. Hence, the system 40 may measure a current translational and/or rotational velocity of the animated object 1, and the animation updating frequency for the object 1 in question may then be reduced as a function of decreasing velocities of the object 1. Hence, the animation of fast-moving objects is updated more frequently than slower-moving objects, for identical relative positions or distances of the moving object in question from the above described point or zone. As to the definition of “translational and/or rotational velocity”, such translational and/or rotational movements may be for the animated object 1 as a whole, such as a coordinate system within which an animation of the object 1 in question takes place being subjected to translational and/or rotational movement in relation to the scene 10. Alternatively, the animation of the object 1 may comprise such translational and/or rotational movements of the object 1 as a part of the animation itself.

It is preferred that, for all objects 1 in the scene 10 an animation updating frequency of which is modified in accordance with the present invention, the animation updating frequency is modified for the whole object 1 in question, so that the animation updating frequency of individual objects 1 is the same for all parts of the same object 1. What constitutes an “object” may, of course, vary depending on the context and application. However, one possible definition of what is an “object” is an entity which is animated in one single context and which cannot easily be separated into several independently animated parts due to animation interactions between such parts. For shader-animated objects 1d, different part of one and the same object 1d may in certain cases have different animation updating frequencies, depending on their respective location in relation to said zone or point.

In many situations, the animation of objects 1 in the scene will be updated once for each rendered frame, so that the animation updating frequency normally is the same as the rendering frame updating frequency. Then, the animation updating frequency of individual objects 1 may be reduced by skipping rendered frames, so that no animation updating is performed for certain rendered frames. For instance, the animation updating frequency of individual objects 1 may be reduced by skipping every 2 rendered frames, every 3 frames, every 4 frames, every 5 frames and so on. It may also be the case that 2 out of 3 rendered frames are skipped, or 3 out of 4 frames, or 4 out of 5 frames, and so forth.

In general, the animation updating frequency of each individual object 1 may be performed by skipping individual animation time points and/or postponing individual animation time points, such as individual animation time points normally being scheduled for the object 1 in question, for instance individual animation time points scheduled in relation to a frame rendering timeline.

In some embodiments, the animation updating frequency of at least one individual object 1 is reduced by at least 10%, or even at least 50%, of a default or normal animation updating frequency used in the absence of an animation updating frequency reduction according to the present invention.

The system 40 may measure a current CPU 44 and/or GPU 45 load, and may then take decisions to skip and/or postpone a particular individual animation time point as a result of detecting a current CPU 44 and/or GPU 45 load which exceeds a corresponding predetermined threshold value. Such skipped and/or postponed animation time points may then be allotted to individual objects 1, where objects having a larger relative position or distance to said zone or point are prioritized for skipping and/or postponing before objects having a smaller such relative position or distance to said zone or point. Alternatively, a general animation updating frequency reduction may be determined based on measured instantaneous CPU 44 and/or GPU 45 load, and then this general reduction may be uniformly distributed to all objects 1 the respective animation frequency of which is to be reduced in accordance with the present invention.

In particular for objects 1 of the type 1c illustrated in FIG. 5, having a skeletal mesh, the system 40 may interpolate between two temporally spaced animated states (that is, states of the object 1 that have actually been animated using the normal animation function of the system 40) to determine an intermediary animated state of the object 1 in w question. Such an intermediary animated state is hence an “artificial” animated state in the sense that it is not constructed using the normal animation function used by the system 40 for animating the object 1 in question, but instead completely determined based on two different animated states and an predetermined interpolation rule. This determination may also be based on the skeletal mesh model of the object 1. Using such interpolation will typically require substantially less CPU 44 time than performing a full animation of the object 1.

Such interpolation is illustrated in FIG. 5, where lc' denotes the leg of the character 1c at a first animation time point. After a certain time has elapsed, such as after two rendering time frames, the leg has moved to the position denoted by 1c′″, according to the animation rules used by the system 40 for animating the character 1c. It is realized that FIG. 5 is simplified, in practise the character 1c would move in several different ways, including movements of the other limbs of the character and also a translational movement to the right in the Figure.

1c″ denotes an interpolated state of the leg, which can be determined by the system 40 by performing an interpolation of the above described type rather than performing a full animation update calculation. The interpolation method used in FIG. 5 is a simple linear interpolation of the joints of the leg. This will result in the individual parts of the leg shifting in shape, and in particular in length. As an alternative, an estimated angular movement of each limb can be used for such interpolation, preserving leg part shape and dimension but changing the relative angles of the different parts of the leg.

Such interpolation will typically save considerable CPU 44 time, and will normally result in adequate visual results in terms of smoothness of the finally rendered animated object 1. However, it forces the animation function to first calculate a next animated state, and then to perform the interpolation. As a result, the animation will be slightly time shifted in relation to the rendering timeline.

In particular for “statically” animated objects, in other words objects the animation of which follows a predetermined, at least partly deterministic path, it may however be possible to perform such interpolation without deteriorating the user experience more than minimally. For such objects, an interpolation may be made between two animation states a latter one of which is known given a previous one of which. For instance, the latter one may then be an expected future animation state of the object in question. Examples of such objects comprise non-character objects (objects without agency) that behave in predictable ways, such as follows the laws of physics. For instance, a wind mill the blades of which are rotating or a swing going back and forth can advantageously be animated using such interpolated animation states.

In order to solve this timing problem, and in particular for objects 1c being defined at least partly in terms of a movable skeletal mesh rather than shader-animated objects, a temporally later skeletal mesh state may be defined as an extrapolation of a current skeletal mesh state, using a current skeletal mesh movement direction and velocity.

For instance, the first animated leg state 1c′ may be followed by the second animated leg state 1c′″. Using these two leg states 1c′, 1c′″ that have actually been determined by the system's 40 animation function using the correct set of animation rules for the object 1c in question, it is possible to calculate a present velocity state of the object 1c, such as including a set of leg part linear or rotational velocities. Such up-to-date velocities may also be read directly from the current data updated and kept by the animation function. Then, using the current skeletal mesh state of the leg 1c′″ and the calculated velocities, the extrapolated state 1c″″ can be calculated without actually performing a full additional animation. Thereafter, a next state can be determined by a full animation step, using the correct animation rules.

The present inventor has discovered that, for many types of skeletal mesh objects, it is possible to achieve sufficiently smooth finally rendered results even without using any higher-order time derivatives of the extrapolated objects then a first-order time derivative (that is, velocity) of said current skeletal mesh state. Thus, no accelerations or higher-order time derivatives are used, only velocities. In many applications, this will also yield smoother finally rendered results.

It is noted that the above described interpolation and/or extrapolation may be produced with more detailed knowledge of the skeletal mesh, such as what parts are interconnected. However, this is not necessary. Instead, the object 1c states can be determined as a set of nodes defining triangles in 3D space (such as a conventional 3D vector model). The interpolation and/or extrapolation may then be calculated as an interpolation and/or extrapolation of the trajectories of the nodes through 3D space. This technique will in fact completely ignore any animation rules used to animate the object in question, and instead only look at the animated object 1 as such.

As described above, a reduction of animation updating frequency may be determined as a function of said determined relative location or distance to the zone or point.

In simple cases, this function may be a step function. In other words, in case the relative location or distance to the zone or point of a particular object 1 is larger than a predetermined value, the animation updating frequency may be a predetermined lower value, otherwise the animation updating frequency may be a higher, default or normal, value.

In alternative cases, said function may comprise a sigmoid function. In other words, the animation updating frequency f as a function of the said relative position or distance x is then varied according to a function being or comprising a sigmoid function: S(x)=e^{x}/(e^{x}+1). This will result in a smooth variation of animation updating frequency among objects 1 in the scene 10, as a function of distance to a current foveal area of the user. Such a sigmoid function may, of course, be scaled and/or normalized properly, or modified in any other conventional way.

One preferred such modification is that said function of said predetermined relative location or distance comprises a constant part at or near said first zone or point. Hence, around a portion of the scene 10 which is currently actively observed by the user, a constant reduction of animation updating frequency for objects is applied; whereas animation updating frequencies of objects located outside of said portion are reduced as a function of a sigmoid function of the relative position or distance as described above. Preferably, the said constant animation updating frequency reduction is zero, so that a default or normal animation updating frequency is used for objects being located inside is said portion. This way, no change in animation updating frequency will be made to an area in the viewport 2 which is currently actively observed by the user.

In this and other cases, an area surrounding a current determined gaze point P₁ corresponding to an angle of at least 5°, preferably at least 10°, more preferably at least 20°, from a current gaze vector from the eye of the user onto the viewport 2 or display screen 41 may be unchanged in terms of object 1 animation updating frequency. How large such an unchanged area will be on the display screen 41 will of course vary with distance between the user and the screen 41 in question.

As described above, the “point” may be the gaze point P₁ determined by the detection means 42 as the point on the screen 41 where the user directs here gaze. However, it may also be any other point along a thought line in virtual 3D space between the user's eyes and the determined gaze point P₁, of a point further away than the gaze point P₁ on the screen 41. This may vary with context.

The “zone” may be a determined foveal area FA. However, it may also be determined based on context-specific logic, such as the virtual extents of a particular part of the scene 10, such as a wall, a room or a part-scene.

As mentioned above, apart from a method of the type described herein, the invention also applies to the system 40 as such, which is arranged to render the virtual scene 10 to produce a rendered presentation of the scene 10. The system 40 is arranged to perform said rendering based on the virtual scene 10 as described above, and to animate the virtual scene 10 based on said set of predefined animation rules.

In particular, the system 40 is arranged to perform the method steps described above, determining the first zone or point; determining the relative location or distance; and modifying the value of the animation updating frequency of the object 1 in question.

Furthermore, the invention relates to a computer software function, arranged to be executed on hardware of the system 40 and to, when executing, perform said rendering of the virtual scene 10 in the mentioned way. The software function is further arranged to, when executing, perform the method steps of the method according to the present invention.

Above, preferred embodiments have been described. However, it is apparent to the skilled person that many modifications can be made to the disclosed embodiments without departing from the basic idea of the invention.

For instance, the method described above may comprise many additional features, apart from the ones described herein, such as a foveal area-dependent rendering resolution variation function.

It is realized that the various techniques for determining under what circumstances and to what extent to reduce the animation updating frequency for each object 1 in the scene 10 may be combined freely. Hence, a relative position or a distance of the object 1 in question may be determined in relation to a determined foveal area FA or to a particular point P₁; the animation updating frequency may be reduced as a linear or non-linear function of such relative position or distance, a viewing distance and/or a velocity and/or a level of detail of the object 1, in any combination.

A computer software function according to the invention may also be an integrated part of a computer game or any other complex computer software function. It may also be installed on a gaze direction detection means such as the means 42 disclosed in FIG. 2.

In general, all which has been said herein regarding the method is equally applicable to the said system and computer software function, and vice versa.

Hence, the invention is not limited to the described embodiments, but can be varied within the scope of the enclosed claims.

1. Method for reducing processor load in a system rendering a virtual scene to produce a rendered presentation of said virtual scene, which scene comprises at least one animated object, wherein the system performs said rendering based on said virtual scene which in turn is animated by the system based on a set of predefined animation rules, wherein the method comprises the steps:
determining, based on information from a gaze direction detection means, a first zone or point of the virtual scene as a zone to which a gaze of the user is currently directed;
determining a relative location or distance of a first object as a location in relation to said first zone or point; and
modifying the value of an animation updating frequency of said first object as a function of said determined relative location or distance.

2. Method according to claim 1, wherein
said animation updating frequency is decreased as a function of increasing relative location or distance of the first object to said first zone or point.

3. Method according to claim 1, wherein
the scene is a three-dimensional, “3D”, scene, which 3D scene is sampled by a rendering function of the system to produce a two-dimensional, “2D”, projection image of the 3D scene , which sampling is performed by the system based on a virtual camera in turn being associated with a camera position and camera direction in the 3D scene.

4. Method according to claim 1, wherein
the first object is defined at least partly in terms of a movable skeletal mesh, and in that
the animation comprises determining a movement of the skeletal mesh of the first object.

5. Method according to claim 4, wherein
said skeletal mesh movement results in an interaction between the first object and a second object in said scene, in turn affecting the animation of the virtual scene.

6. Method according to claim 1, wherein
the animation of the first object comprises a shader animation which shader animation does not result in a geometric interaction between the first object and any other object in the scene.

7. Method according to claim 1, wherein
the system measures a viewing distance of the first object in the virtual scene, and in that the animation updating frequency is reduced as a function of increasing viewing distance of the first object.

8. Method according to claim 1, wherein
the animation updating frequency is reduced as a function of decreasing level of detail, “LOD”, of the first object.

9. Method according to claim 1, wherein
the system measures a current translational and/or rotational velocity of the first object, and in that the animation updating frequency is reduced as a function of decreasing velocities of the first object.

10. Method according to claim 1, wherein
the animation updating frequency is updated so that the animation frequency is reduced to a value which is more than 50% of an original animation updating frequency, by skipping individual animation time points and/or postponing individual animation time points.

11. Method according to claim 1, wherein
the system measures a current CPU and/or GPU load, and decides to skip and/or postpone a particular individual animation time point as a result of detecting a current CPU and/or GPU load which exceeds a corresponding predetermined threshold value.

12. Method according to claim 1, wherein
the system interpolates between two temporally spaced animated states of the first object to determine an intermediary animated state.

13. Method according to claim 1, wherein
the first object is defined at least partly in terms of a movable skeletal mesh, and in that
the method comprises defining a temporally later skeletal mesh state as an extrapolation of a current skeletal mesh state, using a current skeletal mesh movement direction and velocity.

14. Method according to claim 13, wherein
no higher-order time derivatives than a first-order time derivative (velocity) of said current skeletal mesh state are used for said extrapolation.

15. Method according to claim 1, wherein
said function of said determined relative location or distance is a step function.

16. Method according to claim 1 wherein
said function of said determined relative location or distance comprises a sigmoid function.

17. Method according to claim 16, wherein
said function of said predetermined relative location or distance comprises a constant part near said first zone or point.

18. System arranged to render a virtual scene to produce a rendered presentation of said virtual scene , which scene comprises at least one animated object , which system is arranged to perform said rendering based on said virtual scene and to animate said virtual scene based on a set of predefined animation rules, which system is arranged to:
determine, based on information from a gaze direction detection means, a first zone or point of the virtual scene as a zone to which a gaze of the user is currently directed;
determine a relative location or distance of a first object as a location in relation to said first zone or point; and
modify the value of an animation updating frequency of said first object as a function of said determined relative location or distance.

19. Computer software function arranged to, when executing, render a virtual scene to produce a rendered presentation of said virtual scene , which scene comprises at least one animated object , which software function is further arranged to, when executing, is perform said rendering based on said virtual scene and to animate said virtual scene based on a set of predefined animation rules, which software function is further arranged to, when executing:
determine, based on information from a gaze direction detection means , a first zone or point of the virtual scene as a zone to which a gaze of the user is currently directed;
determine a relative location or distance of a first object as a location in relation to said first zone or point; and
modify the value of an animation updating frequency of said first object as a function of said determined relative location or distance.
